(19) United States
(12) Patent Application Publication
(10) Pub. No.: US 2024/0337328 A1
(43) Pub. Date: Oct. 10, 2024

(54) Control Assembly for Valves

(71) Applicant: Hoffman Enclosures Inc., Anoka, MN (US)

(72) Inventors: Scott Stammer, Champlin, MN (US); Richard Raisanen, Coon Rapids, MN (US); Patrick McCarthy, Columbia Heights, MN (US)

(21) Appl. No.: 18/628,464

(22) Filed: Apr. 5, 2024

Related U.S. Application Data
(60) Provisional application No. 63/494,834, filed on Apr. 7, 2023.

(51) Int. Cl. F16K 31/60

(52) U.S. Cl. CPC F16K 31/602; F16K 2200/30

(57) ABSTRACT

A control assembly for a valve or any type of rotatable device can include a handle configured to rotate a valve member of the valve to control flow of fluid through the valve. The handle can include a locking member and a grip portion. The control assembly can include a guide body including a mounting surface, a central aperture, and a plurality of locking features. Each of the plurality of locking features can be spaced apart from a center of the central aperture by a first distance. Each of the plurality of locking features can be arranged to engage the locking member to releasably secure the handle at corresponding rotational orientations. Each rotational orientation can be associated with a corresponding flow configuration for the valve.

### CROSS-REFERENCE TO RELATED APPLICATIONS

This application claims priority to U.S. Provisional Patent Application No. 63/494,834, filed Apr. 7, 2023, the entirely of which is incorporated herein by reference.

### BACKGROUND

The apparatuses and methods disclosed herein relate generally to cooling systems that can be provided for electrical components in data centers.

### SUMMARY

Some embodiments of the present disclosure provide a control assembly for a valve. The control assembly can include a handle configured to rotate a valve member of the valve to control flow of fluid through the valve, where the handle including a locking member and a grip portion. The control assembly can include a guide body including a mounting surface, a central aperture, and a plurality of locking features, where each of the plurality of locking features is spaced apart from a center of the central aperture by a first distance. Each of the plurality of locking features are arranged to engage the locking member to releasably secure the handle at corresponding rotational orientations. Each rotational orientation is associated with a corresponding flow configurations for the valve. The mounting surface is secured to a first structure.

In some embodiments of the control assembly, the locking features include holes arranged to receive the locking member. The locking member may a spring-biased plunger. In some embodiments of the control assembly, the plurality of locking features includes at least three locking features corresponding to at least three rotational orientations of the valve. The at least three rotational orientations may include a first orientation that provides a three-direction flow path through the valve, a second orientation that provides a first two-direction flow path through the valve, and a third orientation that provides a second two-direction flow path through the valve. The at least three rotational orientations may include a fourth rotational orientation that stops fluid flow through the valve. In some embodiments of the control assembly, the guide body comprises a sheet metal member. The guide body may include a first planar portion and a second planar portion, where the plurality of locking features and the aperture are defined in the first planar portion, and the second planar portion is angled relative to the first planar portion. In some embodiments of the control assembly, first structure includes a sheet metal mounting bracket. The sheet metal bracket can be secured to a rail of an enclosure.

Some methods of the present disclosure provide a method of retrofitting a valve. The method for retrofitting a valve includes providing a guide body including a central aperture and a plurality of locking features, where each of the plurality of locking features corresponds to a rotational orientation of a valve. The method includes receiving at least a portion of a valve through the central aperture and securing the guide body to a first bracket, where the first bracket is secured to a structure. The method includes securing a handle to the valve, where the handle includes an aperture, a locking member, and a grip portion, and is configured to rotate a valve member of the valve to control flow of fluid through the valve. An axis of rotation of the handle extends through the aperture and the central aperture. The locking member is configured to engage the locking features to releasably secure the handle in a rotational orientation corresponding to a given locking feature.

In some methods for retrofitting the valve, the locking features include holes in the guide body that are arranged with a predetermined angular spacing relative to each other. A first of the holes may be spaced from a second of the holes by 90 degrees and the second of the holes is spaced from a third of the holes by 90 degrees, relative to the axis of rotation. In some methods for retrofitting the valve, securing the handle to the valve includes inserting a fastener through the aperture and a corresponding aperture of the valve. In some methods for retrofitting the valve, the method may further include securing the guide body to a second bracket. In some methods for retrofitting the valve, both of the guide body and the first bracket may comprise sheet metal members. In some methods for retrofitting the valve, the guide body may define a cut out sized and positioned to at least partially receive a pipe in fluid communication with the valve.

Some embodiments of the present disclosure provide a control assembly for a rotatable device. The control assembly includes a handle configured to be manually rotatable to selectively align the rotatable device in any of a plurality of orientations, where the handle includes a biased locking member. The control assembly includes a guide body that is secured relative to the handle and includes an array of locking holes arranged to receive the biased locking member to releasably secure the rotatable device in any of the plurality of orientations. The guide body is secured to a first structure, the first structure not including the rotatable device.

In some embodiments of the control assembly for a rotatable device, the first structure includes a first bracket, the first bracket being mounted to a horizontal frame member of a rack. In some embodiments of the control assembly for a rotatable device, the guide body comprises a sheet metal member including a first planar portion and a second planar portion, the first planar portion being positioned at an angle relative to the second planar portion.

### BRIEF DESCRIPTION OF THE DRAWINGS

The accompanying drawings, which are incorporated in and form a part of this specification, illustrate embodiments of the present disclosure and, together with the description, serve to explain the principles of embodiments of the present disclosure:

FIG. 1 is a front right isometric view of a rack including an example coolant distribution system, the coolant distribution system including a valve control assembly according to some aspects of the present disclosure;

FIG. 2 illustrates an exploded view for an example valve control assembly, according to an embodiment of the present disclosure;

FIGS. 3A-3C are partial views of the valve control assembly of FIG. 2, illustrating various configurations of the valve control assembly;

FIG. 4 is an isometric view of a handle of the valve control assembly shown in FIG. 2;

FIGS. 5A and 5B are partial views of the valve control assembly of FIG. 2, illustrating an example of a mounting arrangement of the valve control assembly; and

FIG. 6 illustrates another example of a guide body for a valve control assembly.

### DETAILED DESCRIPTION

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the present disclosure. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the present disclosure, of the utilized features and implemented capabilities of such device or system.

Also as used herein, unless otherwise limited or defined, “integral” and derivatives thereof (e.g., “integrally”) describe elements that are manufacture as a single piece without fasteners, adhesive, or the like to secure separate components together. For example, an element stamped as a single-piece component from a single piece of sheet metal, without rivets, screws, or adhesive to hold separately formed pieces together is an integral (and integrally formed) element. In contrast, an element formed from multiple pieces that are separately formed initially then later connected together, is not an integral (or integrally formed) element.

The following discussion is presented to enable a person skilled in the art to make and use embodiments of the present disclosure. Various modifications to the illustrated embodiments will be readily apparent to those skilled in the art, and the generic principles herein can be applied to other embodiments and applications without departing from embodiments of the present disclosure. Thus, embodiments of the present disclosure are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the present disclosure. Skilled artisans will recognize the examples provided herein have many useful alternatives and fall within the scope of embodiments of the present disclosure.

Cooling systems can be provided for data centers to cool electrical components within a data center. During operation, electrical components, typically housed in racks having a standard rack footprint (e.g., a standard height, width, and depth), generate heat. As that heat may degrade electrical components, damage the systems, or degrade performance of the components, cooling systems can be provided for data centers for transferring heat away from racks of the data center with electrical components that need to be cooled.

Cabinets or racks containing electrical equipment are typically arranged in rows within a data center, defining aisles between consecutive rows. Racks can be pre-assembled and “rolled in” to a space in the row adjacent to other racks, the space being pre-defined to have the footprint of a standard rack. This arrangement allows a modular construction of or addition to components in a data center. In some configurations, aisles on opposite sides of a rock of cabinets can be alternately designated as a cold aisle, or a hot aisle, and heat generated by the electrical components of a cabinet can be expelled to the hot air aisle.

Racks within a data center can be integrated with liquid cooling systems of a data center. For example, a rack can include plumbing assemblies, which can include piping, hosing, flow control valves, manifolds, and other elements to control a flow of fluid through the rack (e.g., fluidly between a rack inlet and a rack outlet). In some cases, valves along a plumbing assembly within a rack can be used to selectively allow or deny flow along one or more fluid flow paths. For example, a valve can be a three-way valve, and in a first position, can allow fluid flow along a first flow path (e.g., through a first section of piping or hosing) and in a second position can allow fluid flow along a second flow path (e.g., through a second section of piping or hosing, which can bypass the first fluid flow path). In some cases, it can be advantageous to define intermediate positions for a valve to allow an operator to place the valve in a predefined configuration between a fully-open and a full-closed position. For example, with continued reference to the example three-way valve described above, in some applications (e.g., for some racks integrated into a fluid flow system), it can be advantageous to place the valve in an intermediate position to allow a portion of fluid flow through the first flow path, and a portion of fluid flow through the second flow path. A number of positions required for a given valve can be determined by system requirements, standards, valve applications (e.g., if the valve is a valve of a filtration system, a bypass valve for a heat exchanger, a shutoff valve allowing maintenance of a downstream component, an emergency shutoff valve, etc.) flow profiles, etc. Examples of the present disclosure can provide a low-cost customizable assembly for valves to allow an operator to define positions for a valve according to flow requirements and configurations for particular applications. While the examples provided below describe a control assembly (e.g., a customizable assembly to provide predefined positions for a valve) for use in a rack within a data center (e.g., along a fluid flow path of a liquid cooling system of a data center), the present disclosure is applicable for any fluid flow applications that can require predefined positions for a valve along a flow path of a fluid or a gas (e.g., commercial or residential plumbing systems, industrial flow control for use in manufacturing applications, refrigeration systems, etc.).

As an example, a filtration system can be provided in the cooling systems to remove impurities and particulate matter in a coolant loop. Generally, a filter or strainer can be provided in a fluid path, with valves immediately upstream and downstream of the filter or strainer. The valves can be fluidly coupled with a bypass line, so that, when the valve is moved to a position to shut off flow to the filter or strainer, fluid flow can be routed through the bypass line instead. Thus, flow can be shut off from the filter or strainer by moving the position of the valves upstream and downstream of the valve, rerouting the flow through the bypass line. Once flow is diverted from the filter or strainer, the filter or strainer may be removed or serviced and reinstalled. This can allow a servicing of the filter or strainer without causing downtime to the system. Upon reinstallation of the filter or strainer, the valves can be returned to their default positions, allowing flow through the filter or strainer, and blocking flow through the bypass circuit. Some examples can include multiple filters or strainers similarly arranged (e.g., along parallel flow paths) or other arrangements of valves that can be similarly adjusted to control fluid flow.

Existing control assemblies for a valve provide a sliding sleeve locking handle for securing the position of the valve to direct flow in a particular way (e.g., on a two-way ball valve). These sliding sleeve locking handles can prevent accidental rotation with fully open or closed stops but are generally integrated directly into the valve body and handle, thereby limiting the range of rotation of the handle. Further, this sliding sleeve lock may not be suitable for three-way ball valves, where additional rotation is required to redirect flow in additional directions. Additionally, the sliding sleeve lock handle may be limited for use in a valve with a horizontal orientation, as the sliding sleeve can slide out of the desired locking position in a valve with a vertical orientation. Further, as noted above, a specific application can require intermediate positions for a valve that are customized for the application, and it can be cost-prohibitive to integrate stops directly into a valve body to meet the requirements of a specific application. For example, in some configurations, a particular application can require valves with predefined stops to allow portions of flow through one or more flow paths. A control assembly for a valve, according to some examples can include a predefined position (e.g., a stop) to allow 10% of flow through a first path and 90% of flow through a second path, a predefined positions to allow 50% of flow through the first flow path and 50% of flow through the second flow path, etc. In some examples, any number of predefined positions can be defined for control assemblies to accommodate any number of flow configurations. Other existing control assemblies can provide squeeze triggers to redirect flow. The squeeze triggers can operate both in a valve horizontal or vertical orientation, but the squeeze triggers must be integrated directly into the valve body, thus preventing the use of the squeeze triggers on various existing valve bodies.

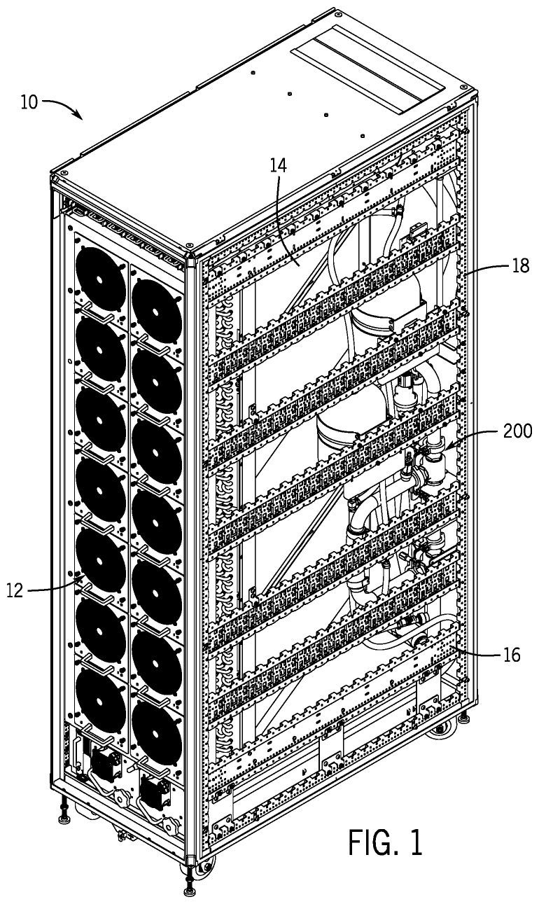

Embodiments of the control assemblies described herein can address these and other issues, and can be used on two-way ball valves, three-way ball valves, or any type of rotatable device. In some examples, a valve control assembly can include a guide body (e.g., a plate or planar member) having one or more locking features (e.g., through-holes, detents, or apertures), and a mounting structure (e.g., a bracket) to fix the guide body relative to a structure (e.g., the mounting rails 16 shown in FIG. 1, as shown below). In some cases, the guide body can be integrally-formed with the mounting structure (e.g., a planar member of the guide body and a bracket of the mounting structure can be integrally formed from a single sheet-metal member). In some cases, a valve control assembly can include a plurality of mounting structures (e.g., a plurality of brackets). The guide body of the valve control assembly can interface with a valve. For example, a rotatable stem of the valve can extend through a corresponding aperture of the guide body. A valve handle can be secured to the rotatable stem (e.g., with a nut, a bolt, a fastener, etc.) and can be engaged to rotate the rotatable stem to control a configuration (e.g., a position) of the valve (e.g., a ball of a ball valve, a gate for a knife valve, a disc of a butterfly valve, etc.) between positions corresponding to the stop features defined on the guide body. The valve handle can include an integrated locking member (e.g., spring-biased plunger) that can be configured to engage with the locking features. For example, a spring-biased plunger or other biased element (e.g., detent ball) can be provided on the valve handle, and can engage with the locking features to ensure the control element of the valve (e.g., a ball for a ball valve, a gate for a knife valve, a disc of a butterfly valve, etc.) is positioned at the desired flow configuration (e.g. fully open, fully closed, partially open along one or more flow paths, etc.). Thus, improved control overflow through the valve can be provided, in contrast to existing control assemblies, which do not provide any position or end stops, and thus can make it difficult to accurately position a valve in the desired flow configuration (e.g., thereby resulting in leakage or undesired restriction of flow).

In some examples, a valve handle can be oriented in various configurations (e.g., positions) relative to the control element of the valve, the configurations corresponding to an array of locking features. In this regard, the bracket can include a plurality of customized locking features for desired flow configurations in a particular application. Further, a guide body, according to some aspects of the present disclosure can exclude locking features for undesired flow configurations, to help ensure that valves are not inadvertently misaligned. The valve handle can be moved to predefined orientations with the locking member of the handle engaging one of the locking features of the guide body to achieve desired flow characteristics. Thus, embodiments of the present disclosure can accommodate for a wide range of potential user needs, in contrast to conventional control assemblies with a limited application.

FIG. 1 illustrates an example rack 10 including a valve control assembly 200, according to some embodiments of the present disclosure. The rack 10 can define an enclosure to house components within a data center. In the illustrated example, the rack 10 is a rack of a liquid-to-air cooling unit, sized to be positionable within a row of electrical equipment (e.g., server racks) within a data center. The rack can include plumbing elements including, for example, piping, filtration elements (e.g., filters, housings for filters, bypass loops for filters, etc.), a liquid inlet and a liquid outlet, and a heat exchanger 14. A liquid coolant (e.g., water, glycol, etc.) can flow into the rack 10 at the liquid inlet, flow through the heat exchanger 14 to cool the liquid coolant, and flow out of the rack 10 at the liquid outlet. In the illustrated example, a plurality of fans 12 generate airflow across the heat exchanger 14, increasing the cooling efficiency of the system. In some embodiments, the fans 12 can further enhance a cooling of the system by directing the air toward a hot aisle, for example.

A rack can include structural elements configured for mounting or securing components within the rack (e.g., a heat exchanger, expansion tanks, plumbing elements, manifolds, etc.). For example, a rack can include a frame with vertical frame members (e.g., rails, or bars), and horizontal frame members at least partially defining a volume of the rack. Mounting rails can be provided along a rack to provide one or more locations (e.g., mounted between vertical or horizontal members of the frame) to which components within the rack can be secured. In the illustrated example of FIG. 1, the rack 10 includes vertical frame members 18, and a plurality of mounting rails 16 in a horizontal configuration (e.g., the mounting rails 16 extend horizontally between opposing vertical frame members 18 of the rack 10). The mounting rails 16 may be used to mount various components within the rack 10 (e.g., the heat exchanger 14, the valve control assembly 200, expansion tanks, manifolds, filtration systems, piping, etc.). In some examples, a rack can include mounting rails in a vertical configuration (e.g., extending between horizontal frame members of the rack). In some embodiments, a plurality of mounting rails can include one or more mounting rails in a horizontal configuration and one or more mounting rails in a vertical configuration. In some examples, a rack includes only one mounting rail, while in other examples, a rack does not include mounting rails. The rack may also include side rails, where, in some embodiments, the plurality of mounting rails is secured to the side rails of the rack.

Use of valve control assemblies as described herein can be particularly beneficial for systems similar to the cooling system illustrated in FIG. 1, including for control of flow relative to filter or strainer assemblies, bypass lines, or other system components. While the present disclosure is described in the context of a rack, the disclosure is not limited to the context of a rack within a data center, but can be equally applicable to any fluid flow systems for which valve control assemblies can be provided. For example, some embodiments of the present disclosure can be useful in a wide range of other contexts, including for valves for other cooling systems, valves for non-cooling flow systems, valves for controlling a flow of gas, or rotating equipment in general. Further, while the present disclosure is described with respect to valves, control assemblies according the present disclosure can provide pre-defined positions for other controls including, for example, electrical knobs, volume controls, lighting controls, or any rotating control that can require predefined positions.

As described above, valve control assemblies can be provided along a fluid flow path, including along plumbing elements housed in racks of a data center. For example, as shown in FIG. 1, the rack 10 includes the valve control assembly 200. In the illustrated example, the valve control assembly 200 is mounted to a mounting rail 16 of the rack 10. As further noted above, valve control assemblies can include one or more valves along a fluid flow path. In some examples, a guide body can be mounted to a structure (e.g., the rack) and integrated with a valve to provide predefined positions for operation of the valve. For example, a feature of the valve (e.g., a valve stem, or a portion of a valve stem assembly) can matingly engage (e.g., can extend through) a corresponding feature (e.g., an aperture) of a guide body, with locking features of the guide body defining operating positions of the valve. In some cases, a valve control assembly includes one or more structural components (e.g., brackets) for securing the guide body to a structure. The guide body may include a plate bracket, a cut out (e.g., a feature to accommodate a pipe or other structural element), and one or more locking features (e.g., apertures, through-holes, detents, etc.), which lock the valve (e.g., to provide predefined valve positions for the valve) in various flow configuration (e.g., open, closed, and flow configurations between open and closed). In some embodiments, the plate bracket is included on a bottom portion of the guide body. In some embodiments, the guide body includes a bottom plate with a bottom cut out. In some embodiments, the guide body includes a top plate, which further includes the cut out, where the cut out is configured to fit plumbing elements.

A mounting bracket may include a top plate. The top plate may include a cut out and one or more tabs. In some embodiments, the cut out is configured to fit plumbing elements. In some embodiments, the tabs are configured to be mechanically connected (e.g., fastened, secured, etc. to the mounting plate of the guide body. In some embodiments, the mounting bracket is secured to one or more mounting rails and/or a side rail.

The mounting plate may include a top plate, where, in some embodiments, the top plate may include a cut out. In some embodiments, the cut out is configured to fit plumbing elements. In other embodiments, the top plate is configured to be secured to the top plate of the guide body. In some embodiments, the mounting plate is secured to one or more mounting rails.

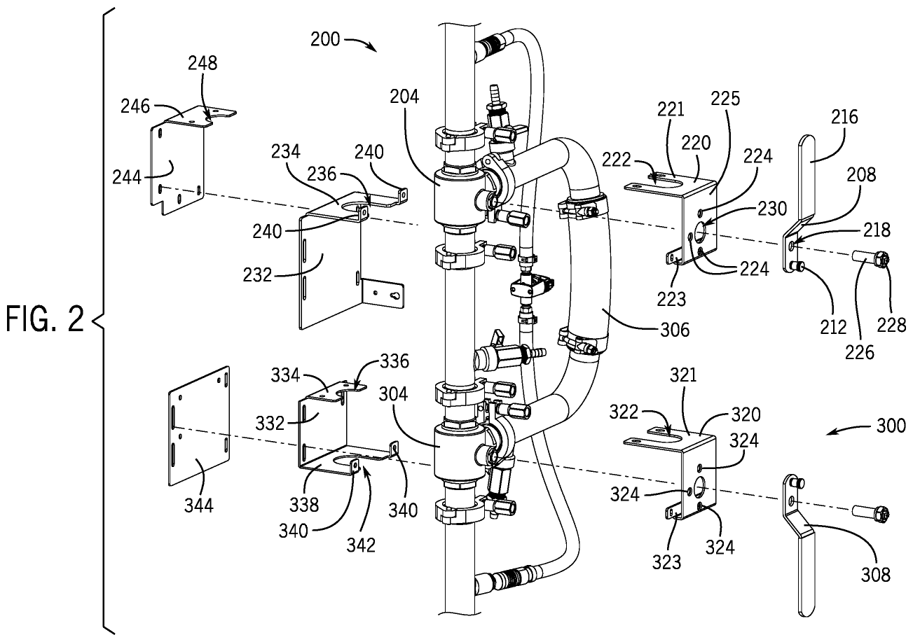

FIG. 2 is an exploded view of the valve control assembly of FIG. 1. In the illustrated example of FIG. 2, the valve control assembly 200 includes a handle 208, a guide body 220, a fastener 226, a first mounting bracket 232, and a second mounting bracket 244. As shown, the handle 208 includes a locking member 212, a grip portion 216, and an aperture 218. The guide body 220 includes a planar interface portion 225, a top planar portion 221, a cut out 222, a mounting lip 223, and a one or more locking features 224. The guide body 220 may also include an aperture 230 (e.g., a central aperture) sized to receive a protruding portion of the valve (e.g., a stem, a portion of a stem assembly, etc.). As shown, the aperture 230 and the locking features 224 are defined on the planar interface portion, and the cutout 222 is defined in the top planar portion 221. As further illustrated, the top planar portion 221 and the planar interface portion 225 are positioned at an angle relative to each other (e.g., a right angle, as shown). The guide body 220 can be a sheet metal member, and the top planar portion and the planar interface portion 225 can be integral with respect to each other (e.g., can be part of the same sheet metal member, bent at an angle relative to each other). In the illustrated example, as described further below, the mounting lip 223 and the top planar portion 221 provide mounting surfaces at which the guide body 220 can be secured to structural members (e.g., the first and second brackets 232, 244). Further, in the illustrated example, each of the guide body 220, the first mounting bracket 232, and the second mounting bracket 244 comprise sheet metal members. In other configurations, any or all of a guide body, and one or more brackets of a valve control assembly can be molded, printed, or otherwise formed from materials other than a sheet metal.

The locking features 224 can be spaced radially from the aperture 230, and, in some examples, the locking features 224 are each substantially equidistant from the aperture (e.g., the locking features are each positioned at the same distance from a center of the aperture 230). In the illustrated example, the aperture 230 is circular, and is sized and shaped to receive a protruding portion of the valve 204. In some examples, an aperture of a guide body for receiving a protruding portion of a valve can define any shape, including, for example, a square, a rectangle, an oval, a shape with one or more curved sides and one or more flat sides, etc. In some cases, a protruding portion of a valve and an aperture of a guide body can interact to limit a rotation of the guide body relative to the valve. For example, a protruding portion of the valve body can be square, and a corresponding aperture of a guide body can be square, and an engagement of the aperture and the protruding portion can prevent rotation of the guide body relative to the protruding portion. In some cases, a geometry of a protruding portion and an aperture of a guide body can perform a guide function to enforce a particular orientation of the guide body relative to the valve. For example, a protruding portion can define a “D” shaped profile, and a corresponding aperture of the guide body can also define a “D” shaped profile, to ensure that the guide body can only be installed in one orientation relative to the valve (e.g., a position of the locking features of the guide body is enforced when the guide body is installed on a valve).

When the guide body 220 is mounted relative to the valve 204, an axis of rotation can be defined in an elongate direction of the fastener 226 (e.g., perpendicular to an elongate direction of the handle 208). In some examples, as shown, the handle 208 is configured to pivot about the fastener 226. For example, the protruding portion of the valve 204 can extend through and be concentric with the aperture 230, and the aperture 218 of the handle 208 aligns with a corresponding aperture of the protruding portion, and the axis of rotation can extend through the apertures 218, 230, and the corresponding aperture of the protruding portion. In the illustrated example, t10he fastener 226 extends through the aperture 218, and the corresponding aperture of the protruding portion. When the handle 208 is secured to the valve 204 at the protruding portion, as described, a rotation of the handle 208 changes a position of the valve 204. The locking member 212 (e.g., the spring-biased plunger) of the handle can be positioned along the handle 208, and a space between the locking member 212 and a center of the aperture 218 can be substantially equal to a distance between the locking features 224 and a center of the aperture 230. Thus, when the handle 208 is installed on the valve 204, the locking member 212 can engage the locking features 224 when the locking member 212 is angularly aligned with the locking features. In some examples, a valve includes a rotatable stem, which can include a threaded end portion. An aperture of a handle can receive the rotatable stem therethrough, and the handle can be secured to the rotatable stem using a nut that engages the threaded end portion. In the illustrated example, the fastener 226 includes a flow indicator 228. A flow indicator can be any marking (e.g., an arrow, a line, a bead, etc.) that can rotate with a handle to align with a flow direction of a valve defined by the handle position. As shown, the flow indicator 228 is configured such that the direction of flow through the valve 204 is indicated by the flow indicator 228.

As further shown in FIG. 2, the guide body can include a top planar portion 221 (e.g., a plate). In the illustrate example, the top planar portion 221 is bent at an angle relative to the portion of the guide body 220 including the locking features 224 and the aperture 230. As shown, the top planar portion include a cutout 222 sized (e.g., having a width and a radius of a rounded section) to receive a pipe upstream or downstream of the valve 204. When a pipe is received into the cutout 222, a rotation of the guide body 220 relative to the valve 204 can be limited. In some embodiments, a guide body can include a bottom planar portion instead of, or in addition to a top planar portion, and a bottom planar portion can include a cutout to at least partially receive piping of a fluid flow system.

It can be beneficial to provide bracket members for a valve control assembly, in addition to a guide body, to provide structural integrity for the valve control assembly, and to further facilitate a mounting of the valve control assembly to a structure (e.g., to the rack 10). A guide body can further include features (e.g., apertures, protrusion, surfaces, etc.) to facilitate engagement with, and coupling to bracket members of a valve control assembly. For example, as further shown in FIG. 2, the valve control assembly 200 can include the first mounting bracket 232 and the second mounting bracket 244. The first mounting bracket 232 can be configured (e.g., sized and shaped) to be secured to a structure (e.g., the mounting rails 16 shown in FIG. 1), and can extend from the structure at a predefined distance and orientation to engage the guide body 220. The second mounting bracket 244 can be configured to engage both of the guide body 220 and the first mounting bracket 232 to provide further support and structural integrity to the valve control assembly 200. For example, as shown, the first mounting bracket 232 includes a top plate 234, a cut out 236, and a one or more tabs 240. The tabs 240 can align with the mounting lip 223 when the valve control assembly 200 is assembled, and the guide body 220 can be secured to the first bracket 232 at an interface between the guide body 220 and the first mounting bracket 232. In some cases, apertures defined in the mounting lip 223 can align with apertures defined in the tabs 240, and fasteners can extend through the respective apertures to secure the guide body 220 to the first mounting bracket 232. In other examples, a guide body and a mounting bracket can be assembled (e.g., the guide body can be secured to the mounting bracket) using any geometries and known assembly methods, including, for example, mating engagement of features, fasteners, welding, locking mechanisms, etc. Further, a first mounting bracket can define any geometry to locate the guide body relative to a structure (e.g., the mounting rail 16). The second mounting bracket 244 can include a top plate 246 and a cut out 248, the cut out 248 sized and shaped to received piping of a fluid flow system. Collectively, the second mounting bracket 244 and the guide body 220 can encompass piping upstream or downstream of the valve 204 (e.g., the cut out 248 can align with the cut out 222, with the piping received into both of the cut out 248 and the cut out 222). The second mounting bracket 244 can be mounted to both of the guide body 220 and the first mounting bracket 232 (e.g., with apertures of the second mounting bracket 244 and of the guide body 220 and the first mounting bracket 232 being aligned to allow insertion of one or more fasteners therethrough). In some example, a valve control assembly does not include a mounting bracket, and a guide body can include a portion that is mounted directly to a structure and a portion that interfaces with a valve to provide stops or locking features defining a position of the valve. In some cases, a valve control assembly includes one mounting bracket, or more than two mounting brackets. A guide body for a valve control assembly and the mounting brackets can be formed from sheet metal and can be stamped or bent to achieve desired geometries. Valve control assemblies can thus provide a low cost of manufacturing as can beneficially allow customization of valve control assemblies for various flow configurations.

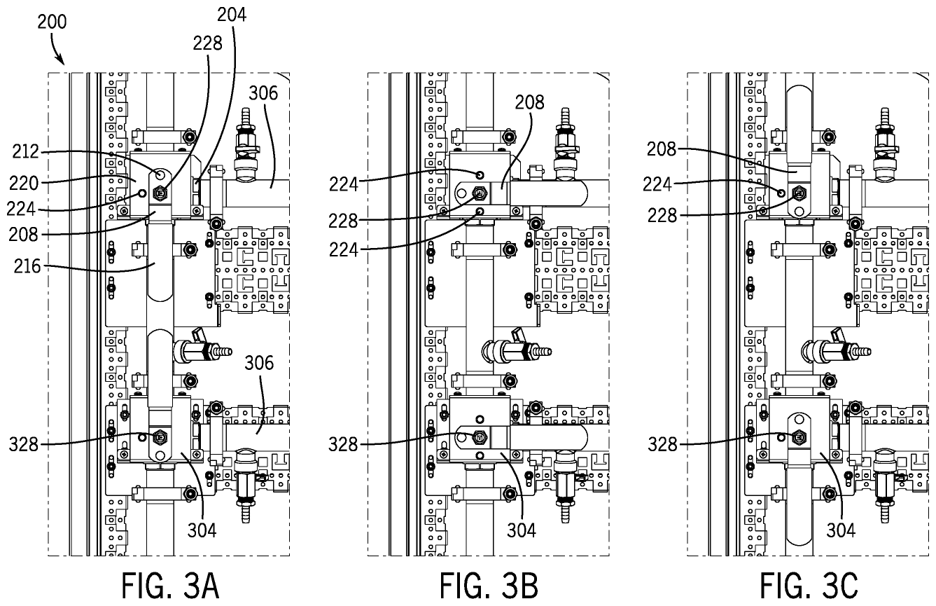

Multiple valve control assemblies can be provided along one or more fluid flow paths within a system (e.g., the liquid-to-air cooling rack 10 shown in FIG. 1). For example, a fluid flow system can include a second valve 304 as shown in FIG. 2, and a valve control assembly 300 can be provided for the second valve 304 to control a position of the second valve 304. In the illustrated example, the valves 204, 304 can be configured to selectively allow fluid through a primary flow path directly between the valves 204, 304 (e.g., a primary flow path including a filter), and a secondary flow path 306 (e.g., a bypass loop). For example, as described further with respect to FIGS. 3A-3C, the valves 204, 304 can be moved to disallow flow through the primary flow path and allow flow through the secondary flow path 306 when a filter along the primary flow path is serviced. In other configurations, one or more valves can be configured to selectively allow or deny all or a portion of flow through only one flow path, or more than two flow paths.

The valve control assembly 300 can include similar elements as the first valve control assembly 200 and can include similar numbering for similar components. The second valve 304 may include substantially similar, and in some instances, substantially identical, components as the first valve 204. In some cases, including as illustrated, the second valve 304 can be differently oriented than the first valve 204, as described further below. In the illustrated example, the second valve control assembly 300 includes a handle 308 that is substantially identical to the handle 208 of the first valve 204, and discussion of the numbered features of the handle 208 generally also applies to the corresponding numbered features of the handle 308. Further, the second valve control assembly 300 can include a guide body 320 that is substantially identical to the guide body 220, and discussion of the numbered features of the guide body 220 generally also applies to the correspondingly numbered features of the guide body 320. For example, the guide body 320 may include a top plate 321, a cut out 322, a mounting lip 323, and a one or more locking features 324, all of which are substantially identical to the components of the guide body 220.

The second valve may also include mounting brackets. In some embodiments, mounting brackets of a second valve control assembly can be similar or identical to mounting brackets of a first valve control assembly. Still referring to FIG. 2, the second valve control assembly 300 includes a third mounting bracket 332 (e.g., similar to the first mounting bracket 232) and a fourth mounting bracket 344 (e.g., similar to the second mounting bracket 244). The third mounting bracket 332 includes a top plate 334 and a bottom plate 338. The top plate 334 includes a top cut out 336, which, in some embodiments, is configured to fit with plumbing components upstream or downstream of the valve 304. The bottom plate 338 includes a one or more tabs 340 and a bottom cut out 342. In some embodiments, the bottom cut out 342 is configured to fit with plumbing components of the valve control assembly 200. In some embodiments, the plurality of tabs 340 are configured to be secured to the mounting lip 323 of the guide body 320. In the illustrated example, the fourth mounting plate 344 is mounted to a structure (e.g., the mounting rails 16) and anchors the second valve control assembly 300 relative to the structure. As shown the valve 304 can be oriented differently relative to a mounting structure than the first valve (e.g., the valve 304 can be positioned at a different distance and in a different direction from one of the mounting rails 16 than the distance and direction of the valve 204 from a mounting rail 16 to which the second mounting bracket 244 is secured). In the illustrated example, the fourth mounting bracket 344 is planar, as can assist in positioning the guide body 320 relative to the valve 304 when the guide body 320 is secured to the fourth mounting bracket 344. In other configurations, additional or fewer mounting brackets can be used for a second vale control assembly. In some cases, a guide body of a second valve control assembly can be secured directly to a structure (e.g., one or more of the mounting rails 16).

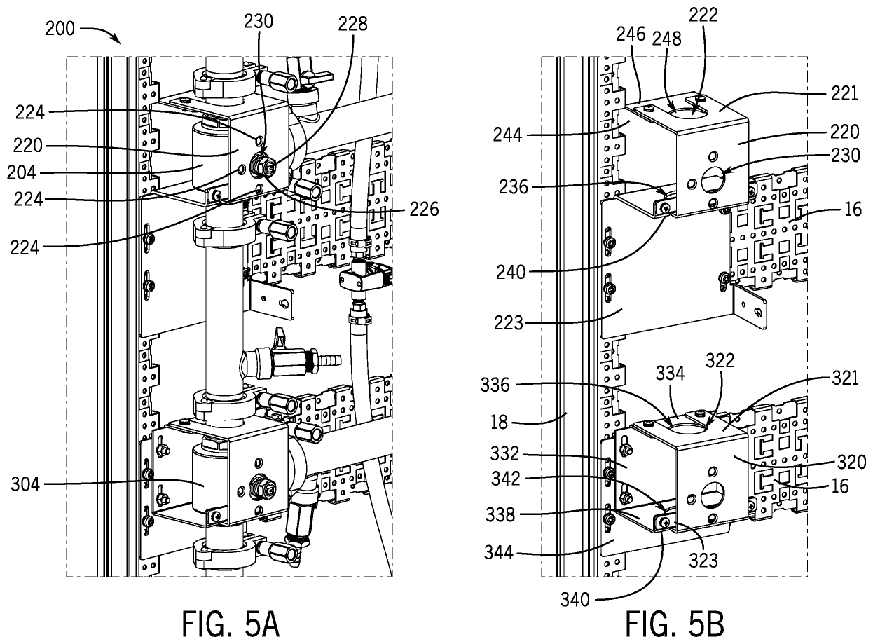

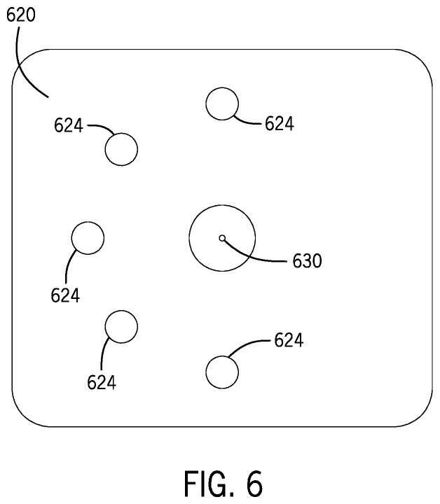

FIGS. 3A-3C illustrate the example valve control assembly 200 for the valve 204 in three different rotational orientations. As shown, the valve control assembly 200 can include the handle 208 that can be configured to rotate a valve member of the valve 204 (e.g., a conventional three-way ball element, not shown) to control flow of fluid through the valve 204. The valve control assembly 200 also includes the guide body 220 that can be secured relative to the handle 208 (e.g., bolted to the valve body, or otherwise installed). In some embodiments, as described above, and illustrated in FIGS. 5A and 5B, a guide body may be secured to other structures (e.g., mounting rails, mounting bracket, mounting plate, etc.). The handle 208 can include the locking member 212 and the grip portion 216. The locking member 212 can be arranged to engage the locking features 224 to releasably secure the handle 208 at different rotational orientations corresponding to different flow configurations for the valve 204. In other words, this arrangement can allow for positive location and retention of the handle 208 of a ball valve to accurately locate the valve 204 in desired positions (e.g., fully open, fully closed, partially open, etc.). In the illustrated example, the guide body 220 includes three locking features 224 corresponding to a fully closed position, a fully open position for a primary fluid flow path, and a fully open position for the second fluid flow path 306 respectively. In other configurations, a guide body can include any number of locking features (e.g., five locking features, as shown in FIG. 6).

As shown in FIGS. 3A-3C, the guide body 220 can include at least three locking features 224 to releasably secure the handle 208 in at least three different rotational orientations. For example, as illustrated in FIG. 3A, the valve control assembly 200 can include a first orientation that can provide a three-direction flow path through the valve 204 (e.g., as illustrated by the T-shaped flow indicator 228 on the valve stem). In the orientation shown in FIG. 3A, as shown by the flow indicator 228, flow can be allowed through each of the three flow ports defined by the valve (e.g., a fluid can enter the valve 204 through the primary flow path directly beneath the valve 204 and through the secondary flow path 306 and can exit in a vertical direction of the valve 204). In some embodiments, in a first configuration shown by the flow indicator 228 and a flow indicator 328 in FIG. 3A, the handle 208 of the first valve 204 and the handle 308 of the second valve 304 may be configured such that overall flow can proceed vertically across the valves 204, 304, and through parallel flow path 306. In the first orientation, the plumbing components between the valves 204, 304, and the plumbing components of the parallel flow path 306 may advantageously experience the same flow, thus lengthening the cycles of use of the plumbing components before requirement maintenance. In other examples, however, other configurations are possible.

In some embodiments of the present disclosure, as illustrated in FIG. 3B, the valve control assembly 200 can include a second orientation that can provide a first two-direction flow path through the valve 204. In this second orientation, as shown by the flow indicator 228 in FIG. 3B, flow is restricted vertically through both of the valves 204, 304 in a bypass vertical mode, so that removal or servicing of a filter or strainer between the valves 204, 304 is possible.

In some embodiments of the present disclosure, as illustrated in FIG. 3C, the valve control assembly 200 can include a third orientation that can provide a second two-direction flow path through the valves 204, 304. In the third orientation, as shown by the flow indicator 228 in FIG. 3C, flow is restricted horizontally in a bypass horizontal mode, so that removal or servicing of a filter, a strainer, or other component along the flow path 306 is possible. Further, the third orientation may define a standard orientation (e.g., standard flow configuration). In a fourth orientation (not shown), the handles 208, 308 may be oriented such that flow is restricted through both the valves 204, 304, and the parallel flow path 306.

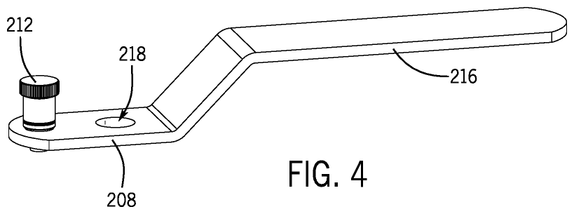

FIG. 4 illustrates the example handle 208 of the valve control assembly 200. As shown, the handle 208 can include the locking member 212, the grip portion 216 and an aperture 218, where the aperture 218 is configured to receive the fastener 226 (see FIG. 2). In some examples, the locking member 212 can be a spring-biased plunger. In other examples, a variety of other biased engagement features is possible, including various known detent arrangements (e.g., spring-biased balls, etc.). In the illustrated example, the locking member 212 is positioned opposite the aperture 218 from the grip portion 216. In other examples, a locking member and a handle can be positioned on a same side of an aperture. In some cases, a handle can include a trigger to selectively engage and disengage a locking member. In other configurations, the locking member 212 may be further from the aperture 218 than shown in the configuration of FIG. 4. In other configurations, the locking member 212 may be closure to the aperture 218 than shown in the configuration of FIG. 4. Further, in other configurations, the locking member 212 may be horizontally offset from a vertical direction defined by the grip portion 216 and the aperture 218. In some cases, a handle can include more than one locking member, as can allow engagement with guide bodies defining customized arrangements of locking features.

In different examples, as also generally described above, a plurality of locking features can be provided. As shown in FIG. 5A, the bracket of the valve control assembly 200 can include a guide body 220 that can include at least three of the locking features 224. In some examples, the locking features 224 can define holes that can be arranged to fully receive the locking member 212 through the guide body 220. In other examples, locking features can be formed as depressions or other formations suitable to engage and removably retain a locking member. Further, the locking features 224 can include a first hole that can be spaced from a second hole by 90 degrees, and a second hole that can be spaced from a third hole by 90 degrees relative to a pivot axis of the valve member, into which the locking member 212 can lock. Thus, for example, a three-way valve can be easily and accurately secured in three different configurations for fully-open flow with three different flow-path configurations (see, e.g., discussion FIGS. 2A-2C).

In a first mounting arrangement, a cut out of a top plate of a guide body and a cut out of a top plate of a mounting bracket can be configured to fit plumbing components on a first side (e.g., an upstream or downstream side) of a valve. A cut out of a top plate of another mounting bracket of the valve control assembly and the guide body can be configured to fit plumbing components on a second side of the valve opposite the first side. In some embodiments, the guide body includes a bottom plate with a bottom cut out, and the bottom cut out of the bottom plate is configured to fit the plumbing components on the bottom of the valve. Further, in the first mounting arrangement, or an offset mounting arrangement, a mounting bracket can be secured to a mounting rail of a rack (e.g., mounting rail 16 shown in FIGS. 1, 5A, and 5B). In other embodiments, the mounting bracket is secured to a horizontal member or a vertical member of the rack. In some embodiments, the mounting bracket is secured to more than one member (e.g., to two mounting rails, or a mounting rail and a vertical or horizontal member of a rack, etc.). In the first mounting arrangement, the valve control assembly includes two mounting brackets and a guide body, with one mounting bracket secured to a mounting rail of a rack.

FIGS. 5A and 5B illustrate components of the valve control assemblies 200, 300 mounted to mounting rails 16 of a rack. In FIG. 5A, the valves 204 and 304 are shown received into valve control assemblies 200 and 300 respectively, with handles of the valve control assemblies 200, 300 removed to provide a clearer view of the mounting arrangements for the valve control assemblies 200, 300. FIG. 5B further illustrates the valve control assemblies 200, 300 with the plumbing elements (e.g., the valves 204, 304) removed to show aspects of the mounting arrangement of the valve control assemblies 200, 300. As shown in FIGS. 5A and 5B, the first mounting bracket 232 is secured to the mounting rail 16. In some cases, a mounting bracket can additionally or alternatively be mounted to a vertical frame member (e.g., vertical frame member 18). The second mounting bracket 244 is secured to the first mounting bracket 232 to secure the second mounting bracket 244 relative to the mounting rail 16 (e.g., relative to the rack 10, as shown in FIG. 1). The guide body 220 is secured to the first mounting bracket 232 (e.g., with the mounting lip 223 secured to the tabs 240 with fasteners). The guide body 220 is further secured to the second mounting bracket 244 (e.g., the top planar portion 221 is secured to the top plate 234 of the second mounting bracket 244). In the first mounting arrangement, the valve 204 (see FIG. 5A) is mounted offset from the mounting rail 16 (e.g., vertically higher than the mounting rail 16), and the first mounting bracket 232 extends from the mounting rail 16 to position the guide body 220. As shown in FIG. 5A, when the guide body 220 is installed, a portion of the valve 204 (i.e., a protruding portion) extends through the aperture 230. A rotational axis for the valve 204 can be defined as being substantially perpendicular to the aperture 230 (e.g., parallel to an elongate direction of the fastener 226).

In a second mounting arrangement, a top cut out of a top plate of a mounting bracket and a cut out of a top plate of a guide body are configured to fit plumbing components on a top of a valve of a control assembly. A bottom cut out of a bottom plate of the mounting bracket and the guide body are configured to fit plumbing components on a bottom of the valve of the control system. In some embodiments, the guide body include a bottom plate with a bottom cut out, and the bottom cut out of the bottom plate is configured to fit the plumbing components on the bottom of the valve of the control system.

Further, in the second mounting arrangement, or a direct mounting arrangement, which secures a valve, a mounting plate is secured to a mounting rail of a rack. In other embodiments, the mounting plate is secured to a side rail of the rack. In some embodiments, the mounting plate is secured to the side rail and the mounting rail. In the second mounting arrangement, a mounting bracket is secured to the mounting plate. In some embodiments, the mounting bracket is secured to the side rail and the mounting plate. A guide body is secured to the mounting bracket and the mounting plate. In the second mounting arrangement, the mounting bracket is mounted directly to the mounting plate in a direct mounting arrangement.

For example, in a second mounting arrangement shown in FIG. 5B, the mounting plate 344 is secured to the mounting rail 16 and the vertical frame member 18. The mounting bracket 332 is secured to the mounting plate 344. The guide body 320 is secured to the mounting bracket 332 via the mounting lip 323 and the tabs 340. The guide body 320 is also secured to the mounting bracket 332 via the top plate 321 of the guide body and the top plate 334 of the mounting bracket 332. In the second mounting arrangement, the valve 304 (see FIG. 5A) is mounted directly to the mounting rail 16, and directly mounting to the mounting plate 344.

In other example, other spacings of holes or other locking features can be used, including to provide flow configurations for different valves, flow configurations that are not fully-opened or fully-closed, or various other arrangements. Thus, generally, a control assembly can include a guide body that can include a plurality of locking features arranged in any variety of predetermined angular spacings relative to each other. Guide bodies can be customized for given applications, and in some cases, a customized guide body can be used with standardized brackets (e.g., a customized guide body can be mounted within a rack, and secured to the first and second brackets 232, 244 as described above). As shown in FIG. 6, for example, in an alternative guide body 620 can include a number of locking features 624 that is different than the number of locking features 224 of the guide body 220. Further, the locking features 624 can be spaced at different angular locations relative to an aperture 630 than the angular locations of the locking features 224 relative to the aperture 230. For example, in the illustrated example, the locking features 624 include five locking features spaced 45 degrees from each other relative to the aperture 630 (e.g., relative to a rotational axis defined as perpendicular to the aperture 630). A variety of other customized hole patterns with alternative angular spacing is possible in other examples. For example, in another possible configuration of a guide body, the locking features can exclude holes for undesired valve positions, thereby helping to prevent alignment for undesired flow configurations for the valve 204. Locking features can be spaced uniformly to provide incremental flow configurations for the valve. In some cases, a spacing of locking features is not uniform.

Thus, embodiments of the present disclosure can provide an improved control assembly for a two-way ball valve, three-way ball valve, or any type of rotatable device. In some embodiments, for example, a control assembly can include a handle with a locking member and a guide body with a plurality of locking features arranged to engage the locking member to releasably secure the handle at different rotational orientations, which can allow positive positioning and retention of the handle to accurately locate a valve in desired positions (e.g., fully open, fully closed).

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

1. A control assembly for a valve comprising:
a handle configured to rotate a valve member of the valve to control flow of fluid through the valve, the handle including a locking member and a grip portion; and
a guide body including a mounting surface, a central aperture, and a plurality of locking features, each of the plurality of locking features being spaced apart from a center of the central aperture by a first distance, each of the plurality of locking features arranged to engage the locking member to releasably secure the handle at corresponding rotational orientations, each rotational orientation associated with a corresponding flow configurations for the valve, the mounting surface being secured to a first structure.

2. The control assembly of claim 1, wherein the locking features include holes arranged to receive the locking member.

3. The control assembly of claim 2, wherein the locking member is a spring-biased plunger.

4. The control assembly of claim 1, wherein the plurality of locking features includes at least three locking features corresponding to at least three rotational orientations of the valve.

5. The control assembly of claim 4, wherein the at least three rotational orientations include:
a first orientation that provides a three-direction flow path through the valve;
a second orientation that provides a first two-direction flow path through the valve; and
a third orientation that provides a second two-direction flow path through the valve.

6. The control assembly of claim 5, wherein the at least three rotational orientations include a fourth rotational orientation that stops fluid flow through the valve.

7. The control assembly of claim 1, wherein the guide body comprises a sheet metal member.

8. The control assembly of claim 7, wherein the guide body includes a first planar portion and a second planar portion, wherein the plurality of locking features and the central aperture are defined in the first planar portion, wherein the second planar portion is angled relative to the first planar portion.

9. The control assembly of claim 1, wherein the first structure includes a sheet metal mounting bracket.

10. The control assembly of claim 9, wherein the sheet metal mounting bracket is secured to a rail of an enclosure.

11. A method of retrofitting a valve, the method comprising:
providing a guide body including a central aperture and a plurality of locking features, each of the plurality of locking features corresponding to a rotational orientation of a valve;
receiving at least a portion of a valve through the central aperture;
securing the guide body to a first bracket, the first bracket being secured to a structure; and
securing a handle to the valve, the handle including an aperture, a locking member, and a grip portion and being configured to rotate a valve member of the valve to control flow of fluid through the valve, wherein an axis of rotation of the handle extends through the aperture and the central aperture, and the locking member is configured to engage the locking features to releasably secure the handle in a rotational orientation corresponding to a given locking feature.

12. The method of claim 11, wherein the locking features include holes in the guide body that are arranged with a predetermined angular spacing relative to each other.

13. The method of claim 12, wherein a first of the holes is spaced from a second of the holes by 90 degrees and the second of the holes is spaced from a third of the holes by 90 degrees, relative to the axis of rotation.

14. The method of claim 11, wherein securing the handle to the valve includes inserting a fastener through the aperture and a corresponding aperture of the valve.

15. The method of claim 11, further comprising securing the guide body to a second bracket.

16. The method of claim 11, wherein the guide body and the first bracket comprise sheet metal members.

17. The method of claim 11, wherein the guide body defines a cut out sized and positioned to at least partially receive a pipe in fluid communication with the valve.

18. A control assembly for a rotatable device, the control assembly comprising:
a handle configured to be manually rotatable to selectively align the rotatable device in any of a plurality of orientations, the handle including a biased locking member; and
a guide body that is secured relative to the handle and includes an array of locking holes arranged to receive the biased locking member to releasably secure the rotatable device in any of the plurality of orientations, wherein the guide body is secured to a first structure, the first structure not including the rotatable device.

19. The control assembly of claim 18, wherein the first structure includes a first bracket, the first bracket being mounted to a horizontal frame member of a rack.

20. The control assembly of claim 18, wherein the guide body comprises a sheet metal member including a first planar portion and a second planar portion, the first planar portion being positioned at an angle relative to the second planar portion.
